(19) United States
(12) Patent Application Publication
(10) Pub. No.: US 2022/0361059 A1
(43) Pub. Date: Nov. 10, 2022

(54) EFFICIENT RADIO RESOURCE MANAGEMENT MEASUREMENTS FOR REDUCED CAPABILITY USER EQUIPMENT

(71) Applicant: QUALCOMM Incorporated, San Diego, CA (US)

(72) Inventors: Linhai HE, San Diego, CA (US); Xipeng ZHU, San Diego, CA (US); Luis Fernando Brisson LOPES, Swindon (GB)

(21) Appl. No.: 17/661,525

(22) Filed: Apr. 29, 2022

Related U.S. Application Data
(60) Provisional application No. 63/201,707, filed on May 10, 2021.

(51) Int. Cl. H04W 36/00

(52) U.S. Cl. CPC H04W 36/0061; H04W 36/0058; H04W 36/00835

(57) ABSTRACT

Various aspects of the present disclosure generally relate to wireless communication. In some aspects, a user equipment (UE) may receive system information that indicates whether one or more neighbor cells support access by UEs in a reduced capability category. The UE may perform one or more radio resource management measurements on one or more neighbor cells that are identified as supporting access by UEs in the RedCap category based at least in part on the system information. Numerous other aspects are described.

### CROSS-REFERENCE TO RELATED APPLICATION

This Patent Application claims priority to U.S. Provisional Patent Application No. 63/201,707, filed on May 10, 2021, entitled “EFFICIENT RADIO RESOURCE MANAGEMENT MEASUREMENTS FOR REDUCED CAPABILITY USER EQUIPMENT,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for efficient radio resource management (RRM) measurements for a reduced capability (RedCap) user equipment (UE).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving system information that indicates whether one or more neighbor cells support access by UEs in a reduced capability (RedCap) category; and performing one or more radio resource management (RRM) measurements on one or more neighbor cells that are identified as supporting access by UEs in the RedCap category based at least in part on the system information.

In some aspects, a method of wireless communication performed by a network node includes receiving information that indicates whether a neighbor cell supports access by UEs in a RedCap category; and transmitting system information that indicates whether the neighbor cell supports access by UEs in the RedCap category.

In some aspects, a UE for wireless communication includes a memory and one or more processors, coupled to the memory, configured to: receive system information that indicates whether one or more neighbor cells support access by UEs in a RedCap category; and perform one or more RRM measurements on one or more neighbor cells that are identified as supporting access by UEs in the RedCap category based at least in part on the system information.

In some aspects, a network node for wireless communication includes a memory and one or more processors, coupled to the memory, configured to: receive information that indicates whether a neighbor cell supports access by UEs in a RedCap category; and transmit system information that indicates whether the neighbor cell supports access by UEs in the RedCap category.

In some aspects, a non-transitory computer-readable medium storing a set of instructions for wireless communication includes one or more instructions that, when executed by one or more processors of a UE, cause the UE to: receive system information that indicates whether one or more neighbor cells support access by UEs in a RedCap category; and perform one or more RRM measurements on one or more neighbor cells that are identified as supporting access by UEs in the RedCap category based at least in part on the system information.

In some aspects, a non-transitory computer-readable medium storing a set of instructions for wireless communication includes one or more instructions that, when executed by one or more processors of a network node, cause the network node to: receive information that indicates whether a neighbor cell supports access by UEs in a RedCap category; and transmit system information that indicates whether the neighbor cell supports access by UEs in the RedCap category.

In some aspects, an apparatus for wireless communication includes means for receiving system information that indicates whether one or more neighbor cells support access by UEs in a RedCap category; and means for performing one or more RRM measurements on one or more neighbor cells that are identified as supporting access by UEs in the RedCap category based at least in part on the system information.

In some aspects, an apparatus for wireless communication includes means for receiving information that indicates whether a neighbor cell supports access by UEs in a RedCap category; and means for transmitting system information that indicates whether the neighbor cell supports access by UEs in the RedCap category.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of make-before-break handover, in accordance with the present disclosure.

FIG. 4 illustrates an example of a wireless network in which a UE may operate in one or more radio resource control communication modes, in accordance with the present disclosure.

FIG. 5 is a diagram illustrating an example associated with efficient radio resource management (RRM) measurements for a reduced capability (RedCap) UE, in accordance with the present disclosure.

FIGS. 6-7 are diagrams illustrating example processes associated with efficient RRM measurements for a RedCap UE, in accordance with the present disclosure.

FIGS. 8-9 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

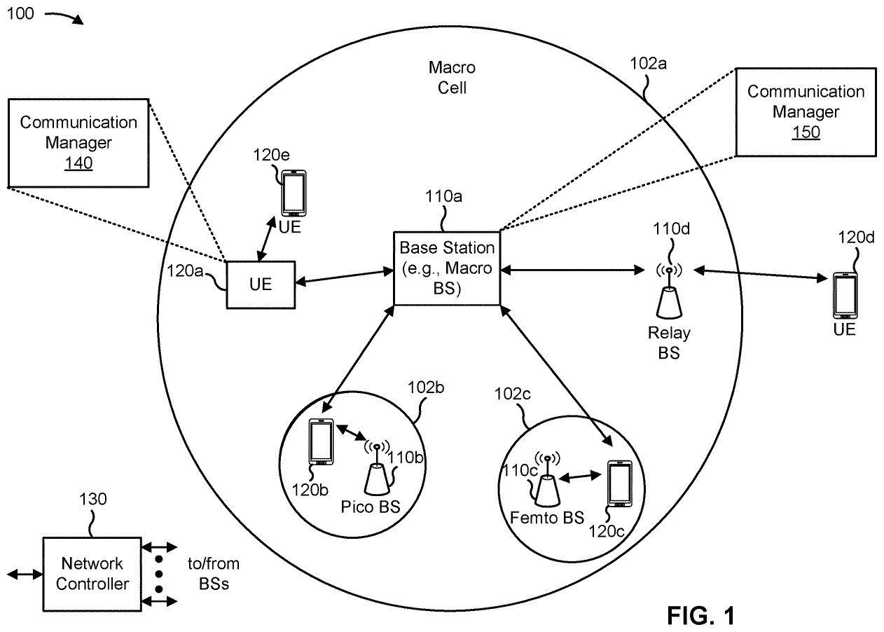

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

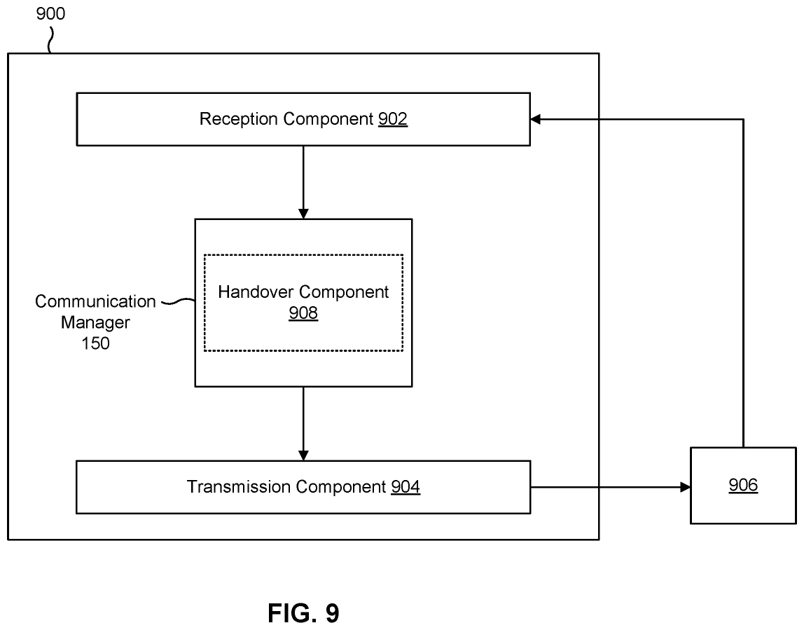

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

Deployment of communication systems, such as 5G New Radio (NR) systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), transmit receive point (TRP), or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

In some aspects, a base station 110 may serve UEs 120 in different categories associated with different capabilities. For example, a base station 110 may serve one or more UEs 120 in a reduced capability (RedCap) category, which may include UEs 120 that have a less advanced capability. In some cases, a UE in the RedCap category may be referred to as a RedCap UE, an NR-Lite UE, a low tier UE, or the like. Additionally, or alternatively, a base station 110 may serve one or more UEs 120 that have a more advanced capability (e.g., relative to UEs 120 in the RedCap category). In some cases, a UE 120 that has a more advanced capability than a RedCap UE 120 may be referred to as a premium UE, an NR UE, a legacy UE, a high tier UE, or the like (in the following, the term “premium or legacy UE” is often used). In some aspects, a UE 120 in a RedCap category may generally have a reduced feature set compared to a UE 120 of a non-RedCap category, such as a premium or legacy UE 120. For example, relative to a premium or legacy UE 120, a RedCap UE 120 may support a lower maximum modulation and coding scheme (MCS) (e.g., quadrature phase shift keying (QPSK) as compared to 256-quadrature amplitude modulation (QAM)), may support a lower transmit power, may have a less advanced beamforming capability, may have a smaller maximum bandwidth, may have fewer antennas (e. g., transmit antennas and/or receive antennas) and/or antenna ports, may be restricted to half-duplex communication, and/or may have a lower power class. Accordingly, one consideration in deploying a wireless network 100 is to compensate for UEs 120 that have different capabilities. For example, a base station 110 that serves UEs 120 having different capabilities may implement functionality to mitigate or limit performance degradation (e.g., potential coverage reduction) that may result from serving a RedCap UE 120 having a reduced complexity.

In some aspects, the UE 120 may include a communication manager 140. As described in more detail elsewhere herein, the communication manager 140 may receive system information that indicates whether one or more neighbor cells support access by UEs 120 in a RedCap category; and perform one or more radio resource management (RRM) measurements on one or more neighbor cells that are identified as supporting access by UEs in the RedCap category based at least in part on the system information. Additionally, or alternatively, the communication manager 140 may perform one or more other operations described herein.

In some aspects, a network node (e.g., the base station 110) may include a communication manager 150. As described in more detail elsewhere herein, the communication manager 150 may receive information that indicates whether a neighbor cell supports access by UEs 120 in a RedCap category; and transmit system information that indicates whether the neighbor cell supports access by UEs 120 in the RedCap category. Additionally, or alternatively, the communication manager 150 may perform one or more other operations described herein.

As indicated above, FIG. 1 is provided as an example. Other examples may differ from what is described with regard to FIG. 1.

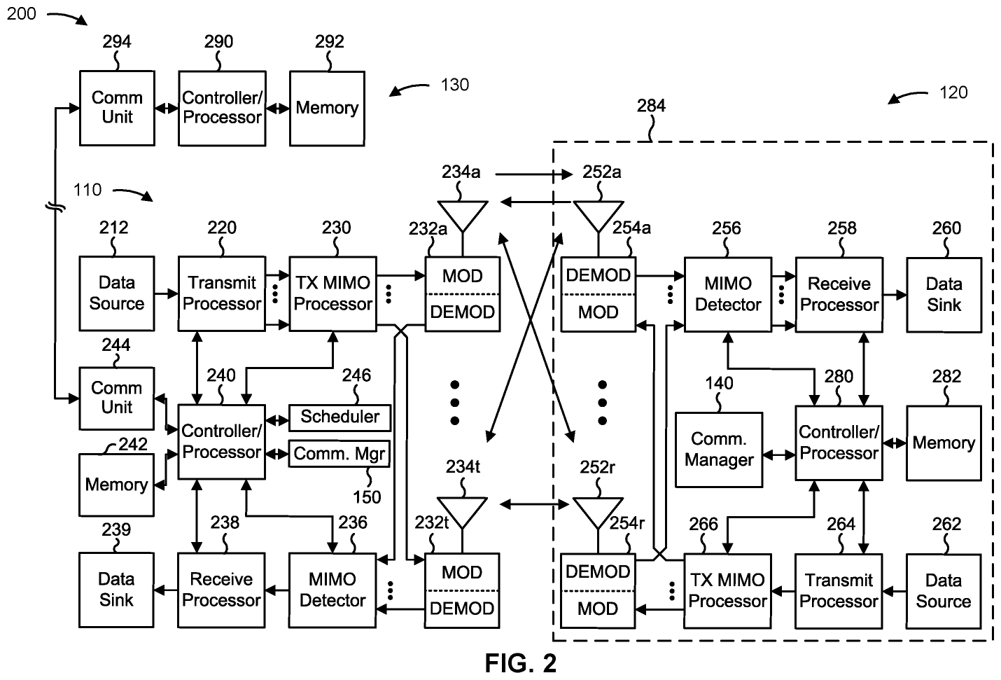

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

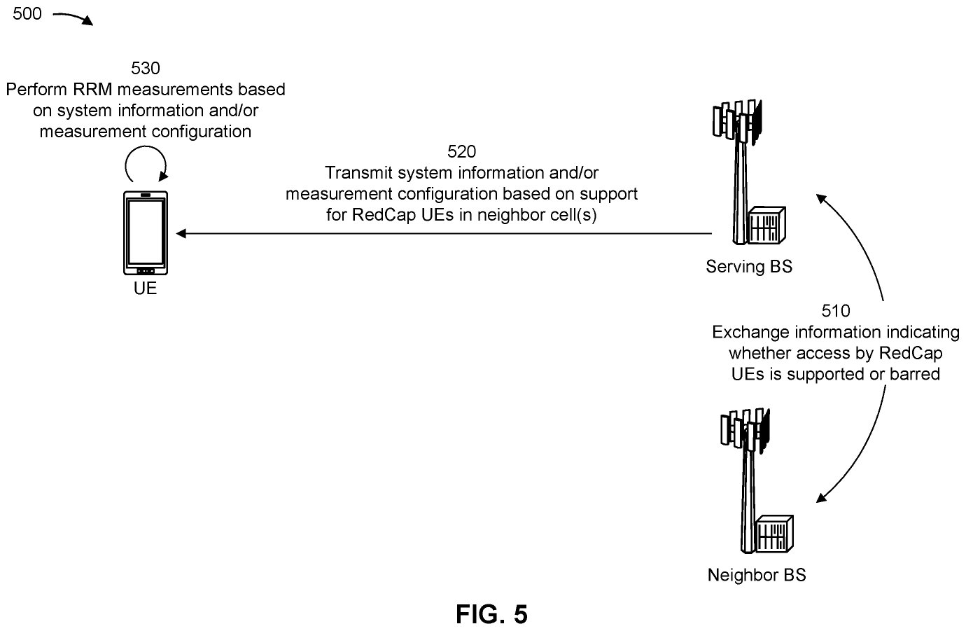

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

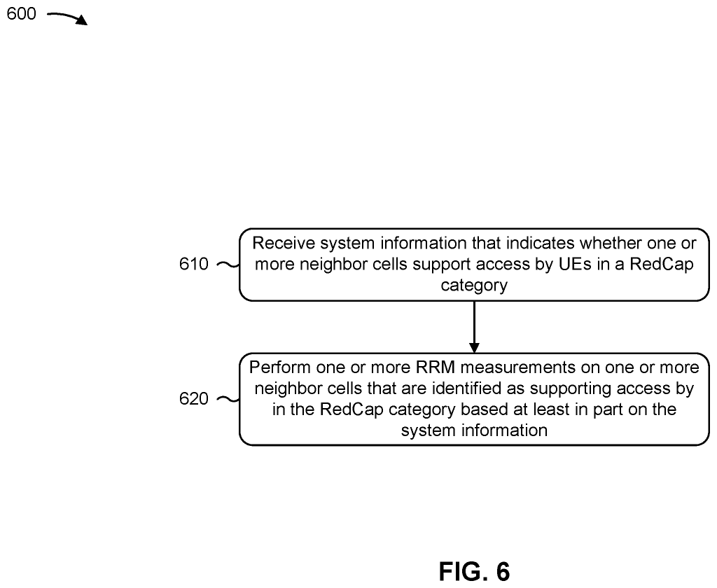

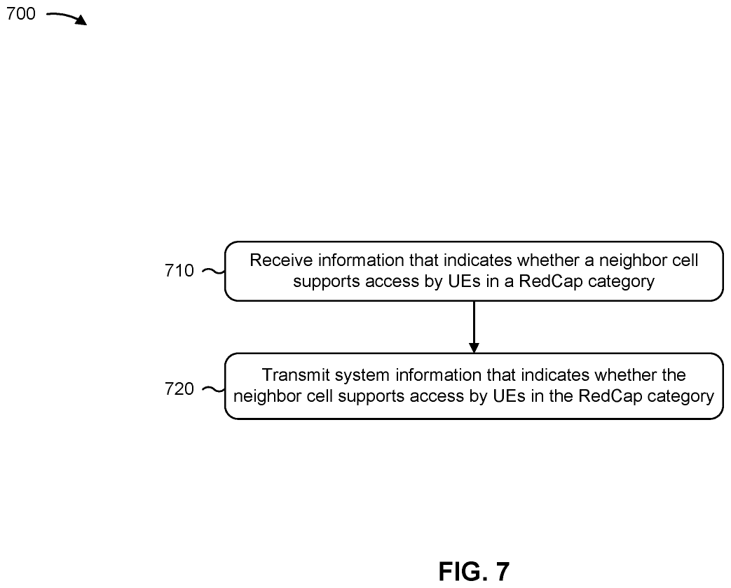

The controller/processor 240 of the base station 110, the controller/processor 280 of the UE 120, and/or any other component(s) of FIG. 2 may perform one or more techniques associated with efficient radio resource management (RRM) measurements for reduced capability (RedCap) UEs, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving system information that indicates whether one or more neighbor cells support access by UEs in a RedCap category; and/or means for performing one or more RRM measurements on one or more neighbor cells that are identified as supporting access by UEs in the RedCap category based at least in part on the system information. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, a network node (e.g., the base station 110) includes means for receiving information that indicates whether a neighbor cell supports access by UEs in a RedCap category; and/or means for transmitting system information that indicates whether the neighbor cell supports access by UEs in the RedCap category. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

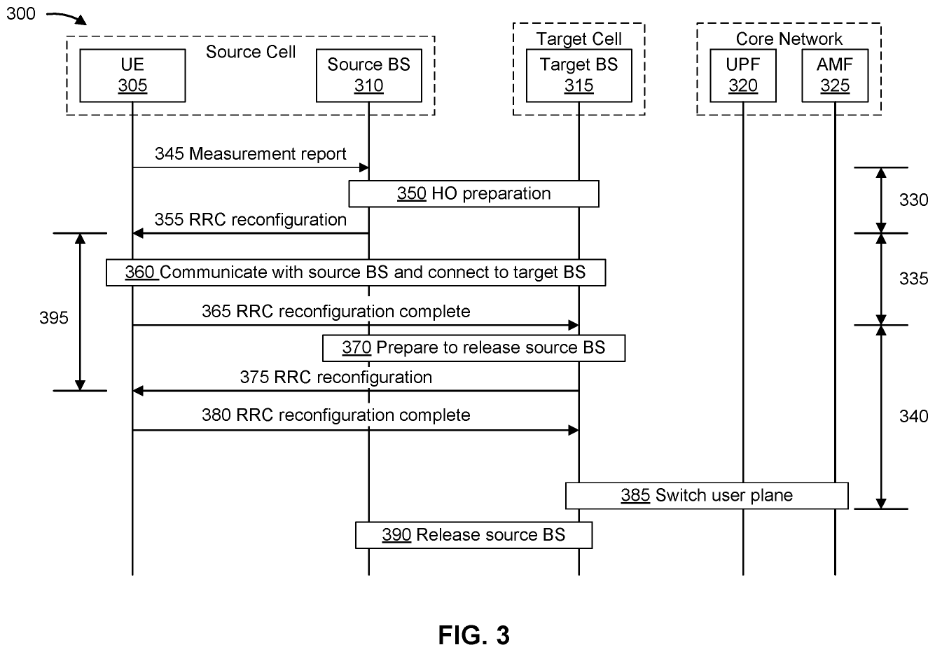

FIG. 3 is a diagram illustrating an example 300 of make-before-break handover, in accordance with the present disclosure.

As shown in FIG. 3, a make-before-break (MBB) handover procedure may involve a UE 305, a source base station 310, a target base station 315, a user plane function (UPF) device 320, and an access and mobility management function (AMF) device 325. The UE 305 may correspond to the UE 120 described elsewhere herein. The source base station 310 and/or the target base station 315 may correspond to the base station 110 described elsewhere herein. The UPF device 320 and/or the AMF device 325 may correspond to the network controller 130 described elsewhere herein. The UE 305 and the source base station 310 may be connected (e.g., may have a radio resource control (RRC) connection) via a serving cell or a source cell, and the UE 305 may undergo a handover to the target base station 315 via a target cell. The UPF device 320 and/or the AMF device 325 may be located within a core network. The source base station 310 and the target base station 315 may be in communication with the core network for mobility support and user plane functions. The MBB handover procedure may include an enhanced MBB (eMBB) handover procedure.

As shown, the MBB handover procedure may include a handover preparation phase 330, a handover execution phase 335, and a handover completion phase 340. During the handover preparation phase 330, the UE 305 may perform one or more radio resource management (RRM) measurements on the source base station 310 and/or one or more neighbor base stations (e.g., including the target base station 315), and may report RRM measurements that cause the source base station 310 and/or the target base station 315 to prepare for handover and trigger execution of the handover. During the handover execution phase 335, the UE 305 may execute the handover by performing a random access procedure with the target base station 315 and establishing an RRC connection with the target base station 315. During the handover completion phase 340, the source base station 310 may forward stored communications associated with the UE 305 to the target base station 315, and the UE 305 may be released from a connection with the source base station 310.

As shown by reference number 345, the UE 305 may perform one or more RRM measurements, and may transmit a measurement report to the source base station 310 based at least in part on performing the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise-ratio (SINR) parameter (e.g., for the serving cell and/or one or more neighbor cells). The source base station 310 may use the measurement report to determine whether to trigger a handover to the target base station 315. For example, if one or more measurements satisfy a condition (e.g., an RSRP measurement associated with the target base station 315 satisfying a threshold and/or exceeding an RSRP measurement associated with the source base station 310), then the source base station 310 may trigger a handover of the UE 305 to the target base station 315.

As shown by reference number 350, the source base station 310 and the target base station 315 may communicate with one another to prepare for a handover of the UE 305. As part of the handover preparation, the source base station 310 may transmit a handover request to the target base station 315 to instruct the target base station 315 to prepare for the handover. The source base station 310 may communicate RRC context information associated with the UE 305 and/or configuration information associated with the UE 305 to the target base station 315. The target base station 315 may prepare for the handover by reserving resources for the UE 305. After reserving the resources, the target base station 315 may transmit an acknowledgement (ACK) to the source base station 310 in response to the handover request.

As shown by reference number 355, the source base station 310 may transmit an RRC reconfiguration message to the UE 305. The RRC reconfiguration message may include a handover command instructing the UE 305 to execute a handover procedure from the source base station 310 to the target base station 315. The handover command may include information associated with the target base station 315, such as a random access channel (RACH) preamble assignment for accessing the target base station 315. Reception of the RRC reconfiguration message, including the handover command, by the UE 305 may trigger the start of the handover execution phase 335.

As shown by reference number 360, during the handover execution phase 335 of the MBB handover, the UE 305 may execute the handover by performing a random access procedure with the target base station 315 (e.g., including synchronization with the target base station 315) while continuing to communicate with the source base station 310. For example, while the UE 305 is performing the random access procedure with the target base station 315, the UE 305 may transmit uplink data, uplink control information, and/or an uplink reference signal (e.g., a sounding reference signal) to the source base station 310, and/or may receive downlink data, downlink control information, and/or a downlink reference signal from the source base station 310.

As shown by reference number 365, upon successfully establishing a connection with the target base station 315 (e.g., via a random access procedure), the UE may transmit an RRC reconfiguration complete message to the target base station 315. Reception of the RRC reconfiguration message by the target base station 315 may trigger the start of the handover completion phase 340.

As shown by reference number 370, the source base station 310 and the target base station 315 may communicate with one another to prepare for release of the connection between the source base station 310 and the UE 305. In some aspects, the target base station 315 may determine that a connection between the source base station 310 and the UE 305 is to be released, such as after receiving the RRC reconfiguration complete message from the UE 305. In this case, the target base station 315 may transmit a handover connection setup complete message to the source base station 310. The handover connection setup complete message may cause the source base station 310 to stop transmitting data to the UE 305 and/or to stop receiving data from the UE 305. Additionally, or alternatively, the handover connection setup complete message may cause the source base station 310 to forward communications associated with the UE 305 to the target base station 315 and/or to notify the target base station 315 of a status of one or more communications with the UE 305. For example, the source base station 310 may forward, to the target base station 315, buffered downlink communications (e.g., downlink data) for the UE 305 and/or uplink communications (e.g., uplink data) received from the UE 305. Additionally, or alternatively, the source base station 310 may notify the target base station 315 regarding a packet data convergence protocol (PDCP) status associated with the UE 305 and/or a sequence number to be used for a downlink communication with the UE 305.

As shown by reference number 375, the target base station 315 may transmit an RRC reconfiguration message to the UE 305 to instruct the UE 305 to release the connection with the source base station 310. Upon receiving the instruction to release the connection with the source base station 310, the UE 305 may stop communicating with the source base station 310. For example, the UE 305 may refrain from transmitting uplink communications to the source base station 310 and/or may refrain from monitoring for downlink communications from the source base station 310.

As shown by reference number 380, the UE may transmit an RRC reconfiguration complete message to the target base station 315 to indicate that the connection between the source base station 310 and the UE 305 is being released or has been released.

As shown by reference number 385, the target base station 315, the UPF device 320, and/or the AMF device 325 may communicate to switch a user plane path of the UE 305 from the source base station 310 to the target base station 315. Prior to switching the user plane path, downlink communications for the UE 305 may be routed through the core network to the source base station 310. After the user plane path is switched, downlink communications for the UE 305 may be routed through the core network to the target base station 315. Upon completing the switch of the user plane path, the AMF device 325 may transmit an end marker message to the source base station 310 to signal completion of the user plane path switch. As shown by reference number 390, the target base station 315 and the source base station 310 may communicate to release the source base station 310.

As part of the MBB handover procedure, the UE 305 may maintain simultaneous connections with the source base station 310 and the target base station 315 during a time period 395. The time period 395 may start at the beginning of the handover execution phase 335 (e.g., upon reception by the UE 305 of a handover command from the source base station 310) when the UE 305 performs a random access procedure with the target base station 315. The time period 395 may end upon release of the connection between the UE 305 and the source base station 310 (e.g., upon reception by the UE 305 of an instruction, from the target base station 315, to release the source base station 310). By maintaining simultaneous connections with the source base station 310 and the target base station 315, the handover procedure can be performed with zero or a minimal interruption to communications, thereby reducing latency.

As indicated above, FIG. 3 is provided as an example. Other examples may differ from what is described with respect to FIG. 3.

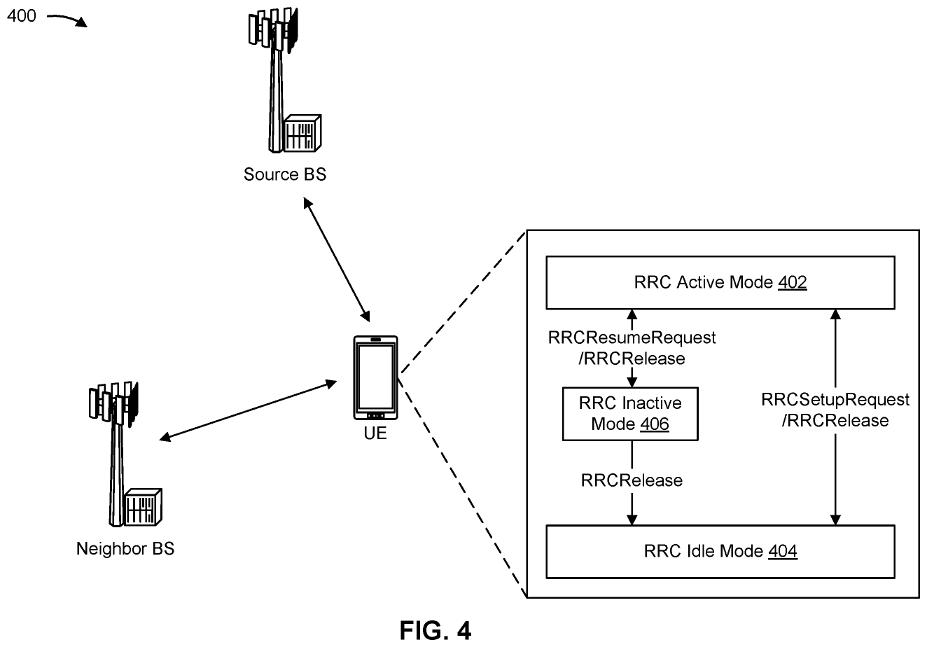

FIG. 4 illustrates an example 400 of a wireless network (e.g., wireless network 100) in which a UE (e.g., UE 120) may operate in one or more RRC communication modes, in accordance with the present disclosure. The UE may be communicatively connected with a source base station in the wireless network. Furthermore, in some aspects, the UE may be located within or near the coverage area of one or more neighbor base stations.

As shown in FIG. 4, the UE may support a connected communication mode (e.g., an RRC active mode 402), an idle communication mode (e.g., an RRC idle mode 404), and an inactive communication mode (e.g., an RRC inactive mode 406). The RRC inactive mode 406 may functionally reside between the RRC active mode 402 and the RRC idle mode 404.

The UE may transition between different modes based at least in part on various commands and/or communications received from the source base station. For example, the UE may transition from the RRC active mode 402 or the RRC inactive mode 406 to the RRC idle mode 404 based at least in part on receiving an RRCRelease communication from the source base station. As another example, the UE may transition from the RRC active mode 402 to the RRC inactive mode 406 based at least in part on receiving an RRCRelease with suspendConfig communication from the source base station. As another example, the UE may transition from the RRC idle mode 404 to the RRC active mode 402 based at least in part on receiving an RRCSetupRequest communication from the source base station. As another example, the UE may transition from the RRC inactive mode 406 to the RRC active mode 402 based at least in part on receiving an RRCResumeRequest communication from the source base station.

When transitioning to the RRC inactive mode 406, the UE and/or the source base station may store a UE context (e.g., an access stratum (AS) context and/or higher-layer configurations). This permits the UE and/or the source base station to apply the stored UE context when the UE transitions from the RRC inactive mode 406 to the RRC active mode 402 in order to resume communications with the source base station, which reduces latency of transitioning to the RRC active mode 402 relative to transitioning to the RRC active mode 402 from the RRC idle mode 404. Additionally, or alternatively, the source base station may provide the stored UE context to the neighbor base station to facilitate a handover for the UE, as described in further detail elsewhere herein.

In some cases, the UE may communicatively connect with a new source base station when transitioning from the RRC idle mode 404 or the RRC inactive mode 406 to the RRC active mode 402 (e.g., the UE may perform cell reselection to the neighbor base station if one or more RRM measurements associated with the source base station or the neighbor base station satisfy a condition).

In all RRC states, the UE may periodically perform RRM measurements on one or more neighbor cells. For example, in some aspects, the source base station may transmit a system information block (SIB) that indicates a set of neighbor cells associated with the source base station, and the UE may perform RRM measurements on the set of neighbor cells indicated in the SIB when the UE is in the RRC active mode 402, the RRC idle mode 404, the RRC inactive mode 406, or any other suitable RRC mode. For example, the set of neighbor cells may be indicated in SIB2, which contains parameters related to intra-frequency, inter-frequency, and/or inter-RAT cell reselection, in SIB3, which contains parameters related to intra-frequency cell reselection only, in SIB4, which contains parameters related to inter-frequency cell reselection only, and/or in SIB5, which contains parameters related to inter-RAT cell reselection only. In this case, when the UE is in the RRC idle mode 404 or the RRC inactive mode 406, the UE may reselect a neighbor cell associated with the neighbor base station as a new serving cell based on one or more RRM measurements satisfying a condition (e.g., when the RSRP measurement associated with the neighbor base station satisfies a threshold and/or exceeds the RSRP measurement associated with the source base station, among other examples).

Additionally, or alternatively, in the RRC active mode 402, the source base station may provide a measurement configuration to the UE, and the measurement configuration may indicate one or more neighbor cells that the UE is to measure and/or how often the UE is to measure the one or more neighbor cells indicated in the measurement configuration. Accordingly, in the RRC active mode 402, the UE may send measurement reports to the source base station periodically, on-demand, and/or based on a triggering event (e.g., an RSRP measurement associated with one or more neighbor cells satisfying a configured threshold). In some aspects, as described herein, a source cell (e.g., the source base station) may decide whether and/or when to facilitate a handover for the UE to a new serving cell (e.g., a target cell provided by the neighbor base station) based on the measurement report provided by the UE.

Accordingly, as described herein, the UE may perform (e.g., obtain) and report RRM measurements in all RRC states in order to support mobility and improved performance for the UE (e.g., to determine whether to perform cell reselection to a neighbor cell in the RRC idle mode 404 or the RRC inactive mode 406 and/or to determine whether to initiate a handover to a neighbor cell that may offer better performance than the UE is experiencing in the source cell in the RRC active mode 402). However, performing RRM measurements on one or more neighbor cells may lead to inefficiencies in cases where the UE is in a reduced capability (RedCap) category. For example, as described herein, relative to a premium or legacy UE, a RedCap UE may support a lower maximum MCS (e.g., quadrature phase shift keying (QPSK) as compared to 256-quadrature amplitude modulation (QAM)), may support a lower transmit power, may have a less advanced beamforming capability, may have a smaller maximum bandwidth, may have fewer antennas (e. g., transmit antennas and/or receive antennas) and/or antenna ports, may be restricted to half-duplex communication, and/or may have a lower power class.

Accordingly, in some cases, a base station may implement functionality to mitigate or limit performance degradation (e.g., potential coverage reduction) that may result from serving a RedCap UE, which may require more network resources to serve due to the limited capabilities. For example, in a case where a RedCap UE has one (1) receive antenna, there may be at least a six decibel (dB) loss in a link budget. To compensate the loss in the link budget, a base station serving the RedCap UE may use multiple repetitions for downlink transmissions to the RedCap UE to ensure that the RedCap UE has the same coverage as a non-RedCap (e.g., premium or legacy) UE. As a result, a base station may bar RedCap UEs from accessing a cell provided by the base station separately from non-RedCap UEs. For example, when cell loading increases, the base station may block RedCap UEs from accessing the cell, whereby cell barring for RedCap UEs may be more dynamic (e.g., change more frequently) than for non-RedCap legacy UEs. Accordingly, in cases where a RedCap UE performs RRM measurements on one or more neighbor cells, performing the RRM measurements on a neighbor cell that does not support access by RedCap UEs (e.g., RedCap UEs are temporarily or permanently barred from accessing the neighbor cell) wastes the limited resources of the RedCap UE (e.g., by increasing power consumption). Furthermore, inefficiencies (e.g., increased handover latency and/or signaling overhead) may occur if a source cell were to initiate a handover for a RedCap UE to a target cell that does not support access by RedCap UEs. For example, the target cell that does not support access by RedCap UEs may reject the handover request from the source cell, which then has to attempt to initiate a handover to a different target cell that may also reject the handover request if the other target cell does not support access by RedCap UEs.

Some aspects described herein relate to techniques and apparatuses to increase efficiency of RRM measurements by RedCap UEs. For example, cells (e.g., base stations) in a wireless network may exchange information with neighbor cells to indicate whether the respective cells support access by RedCap UEs (e.g., RedCap UEs are permitted to access the cell) or do not support access by RedCap UEs (e.g., RedCap UEs are temporarily or permanently barred from accessing the cell). Each cell may transmit system information to indicate whether the neighbor cells support or bar access by RedCap UEs such that a RedCap UE may determine whether to measure the neighbor cells in the RRC idle mode 404 or the RRC inactive mode 406 (e.g., the Redcap UE may refrain from measuring or attempting to perform cell reselection to a neighbor cell that does not support access by RedCap UEs). Additionally, or alternatively, a measurement configuration that a cell provides to a RedCap UE in the RRC active mode 402 may exclude any neighbor cells that do not support access by RedCap UEs such that the RedCap UE does not measure the neighbor cells that do not support access by RedCap UEs in the RRC active mode 402. Furthermore, the serving cell for a RedCap UE may exclude any neighbor cells that do not support access by RedCap UEs from a handover decision for the RedCap UE. In this way, RedCap UEs may conserve resources that would otherwise be wasted measuring neighbor cells that do not support access by RedCap UEs and/or signaling overhead and handover latency may be reduced by excluding neighbor cells that do not support access by RedCap UEs from measurements and/or handover decisions in the RRC active mode 402.

As indicated above, FIG. 4 is provided as an example. Other examples may differ from what is described with regard to FIG. 4.

FIG. 5 is a diagram illustrating an example 500 associated with efficient RRM measurements for a RedCap UE, in accordance with the present disclosure. As shown in FIG. 5, example 500 includes communication between a UE (e.g., UE 120) and a serving base station (e.g., base station 110) and communication between the serving base station and a neighbor base station (e.g., base station 110). In some aspects, the UE, the serving base station, and the neighbor base station may be included in a wireless network, such as wireless network 100. The serving base station and the UE may communicate via a wireless access link, which may include an uplink and a downlink. Furthermore, the serving base station and the neighbor base station may communicate via a backhaul link, such as an operations, administration, and management (OAM) interface or an inter-node messaging interface (e.g., an F1 interface, an NG interface, and/or an Xn interface). In some aspects, as described herein, the UE may be a RedCap UE, the serving base station may be referred to as a serving cell, and the neighbor base station may be referred to as a neighbor cell.

As shown in FIG. 5, and by reference number 510, cells in a wireless network may exchange information that indicates whether access by RedCap UEs is supported (e.g., permitted) or unsupported (e.g., temporarily or permanently restricted). For example, as shown, the serving cell associated with the UE may transmit, and the neighbor cell may receive (e.g., over the OAM or inter-node messaging interface), information that indicates whether the serving cell supports access by RedCap UEs. Furthermore, the neighbor cell may transmit, and the serving cell may receive (e.g., over the OAM or inter-node messaging interface), information that indicates whether the neighbor cell supports access by RedCap UEs. In some aspects, a cell may generally transmit the information that indicates whether access by RedCap UEs is supported or unsupported based on a change in a setting related to whether access by RedCap UEs is supported or unsupported. For example, the serving cell and/or the neighbor cell may transmit information to advertise whether access by RedCap UEs is supported or unsupported when there is a change from supporting to not supporting access by RedCap UEs or a change from not supporting to supporting access by RedCap UEs. In this way, each cell in the wireless network may know whether each neighbor cell currently supports or does not support access by RedCap UEs such that that system information and/or measurement configurations can be configured to enable more efficient RRM measurements by RedCap UEs and/or more efficient handover decisions for RedCap UEs.

For example, as shown by reference number 520, the serving cell may transmit, and the UE may receive, system information and/or a measurement configuration that is based at least in part on support for access by RedCap UEs in one or more neighbor cells. For example, the serving cell may transmit a SIB that identifies a set of neighbor cells associated with the serving cell, and the SIB may further indicate whether each neighbor cell supports or does not support access by RedCap UEs. In some aspects, the SIB that indicates whether the neighbor cells support or do not support access by RedCap UEs may be a SIB that contains information related to cell reselection parameters applicable to RedCap UEs. For example, the SIB that indicates whether the neighbor cells support or do not support access by RedCap UEs may be SIB2, which contains parameters related to intra-frequency, inter-frequency, and/or inter-RAT cell reselection, SIB3, which contains parameters related to intra-frequency cell reselection only, or SIB4, which contains parameters related to inter-frequency cell reselection only. In this way, when the UE performs RRM measurements in an RRC idle mode or an RRC inactive mode, the UE may identify any neighbor cells that do not support access by RedCap UEs based on the system information received from the serving cell and refrain from performing RRM measurements on such neighbor cells. In other words, when the UE performs RRM measurements in the RRC idle mode or the RRC inactive mode, the system information that indicates whether the neighbor cells support or do not support access by RedCap UEs may enable the UE to measure only one or more neighbor cells that support access by RedCap UEs. In this way, the UE may avoid wasting resources measuring or attempting to perform cell reselection for neighbor cells that do not support access by RedCap UEs.

Additionally, or alternatively, when the UE is in an RRC connected or active mode, the serving cell may transmit a measurement configuration that identifies one or more neighbor cells on which the UE is to perform RRM measurements. In this case, the serving cell may exclude any neighbor cells that do not support access by RedCap UEs from the measurement configuration. In other words, a measurement configuration provided to the UE in the RRC connected or active mode may include only one or more neighbor cells that support access by RedCap UEs such that the UE may avoid wasting resources measuring or attempting to perform a handover to a neighbor cell that does not support access by RedCap UEs. Furthermore, the serving cell may exclude any neighbor cells that do not support access by RedCap UEs from a handover decision for the UE in the RedCap category.

As further shown in FIG. 5, and by reference number 530, the UE may perform one or more RRM measurements on one or more neighbor cells based on the system information or measurement configuration received from the serving base station. For example, in the RRC idle or inactive mode, the UE may identify a set of neighbor cells in the system information received from the serving cell (e.g., in SIB2, SIB3, or SIB4). As described above, the system information may indicate whether each neighbor cell supports or does not support access by RedCap UEs. Accordingly, when performing the RRM measurements in the RRC idle or inactive mode, the UE may perform the RRM measurements on one or more neighbor cells that support access by RedCap UEs and may refrain from performing RRM measurements on any neighbor cells that do not support access by RedCap UEs. In this way, indicating in system information whether the neighbor cells support or do not support access by RedCap UEs may enable the UE to conserve resources that may otherwise be wasted measuring neighbor cells that do not support access by RedCap UEs and/or performing cell reselection to a neighbor cell that does not support access by RedCap UEs.

Additionally, or alternatively, in the RRC connected or active mode, the UE may determine one or more neighbor cells to be measured based on the measurement configuration provided by the serving cell. In this case, as described above, the measurement configuration may exclude any neighbor cells that do not support access by RedCap UEs. Accordingly, when performing the RRM measurements in the RRC connected or active mode, the UE may perform the RRM measurements only on neighbor cells that support access by RedCap UEs. In this way, excluding neighbor cells that do not support access by RedCap UEs from a measurement configuration may enable the UE to conserve resources that may otherwise be wasted measuring neighbor cells that do not support access by RedCap UEs and/or attempting to initiate a handover to a neighbor cell that does not support access by RedCap UEs.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with efficient RRM measurements for a RedCap UE.

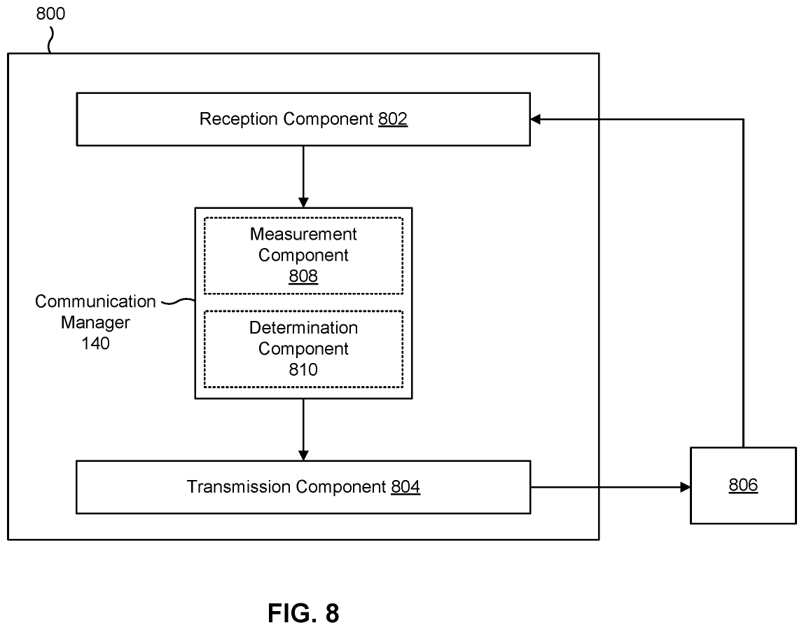

As shown in FIG. 6, in some aspects, process 600 may include receiving system information that indicates whether one or more neighbor cells support access by UEs in a RedCap category (block 610). For example, the UE (e.g., using communication manager 140 and/or reception component 802, depicted in FIG. 8) may receive system information that indicates whether one or more neighbor cells support access by UEs in a RedCap category, as described above.

As further shown in FIG. 6, in some aspects, process 600 may include performing one or more RRM measurements on one or more neighbor cells that are identified as supporting access by UEs in the RedCap category based at least in part on the system information or the measurement configuration (block 620). For example, the UE (e.g., using communication manager 140 and/or measurement component 808, depicted in FIG. 8) may perform one or more RRM measurements on one or more neighbor cells that are identified as supporting access by UEs in the RedCap category based at least in part on the system information or the measurement configuration, as described above.

Process 600 may include additional aspects, such as any single aspect or any combination of aspects described below and/or in connection with one or more other processes described elsewhere herein.

In a first aspect, the system information is received in a SIB that contains information related to cell reselection parameters.

In a second aspect, alone or in combination with the first aspect, the SIB is SIB2, SIB5, or SIB4.

In a third aspect, alone or in combination with one or more of the first and second aspects, process 600 includes receiving a measurement configuration, wherein the one or more neighbor cells on which the one or more RRM measurements are performed are identified based at least in part on the measurement configuration.

In a fourth aspect, alone or in combination with one or more of the first through third aspects, the measurement configuration excludes any neighbor cells that do not support access by UEs in the RedCap category.

In a fifth aspect, alone or in combination with one or more of the first through fourth aspects, process 600 includes determining, based at least in part on the system information, at least one neighbor cell that does not support access by UEs in the RedCap category, and refraining from performing RRM measurements on the at least one neighbor cell that does not support access by UEs in the RedCap category.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with the present disclosure. Example process 700 is an example where the base station (e.g., base station 110) performs operations associated with efficient RRM measurements for a RedCap UE.

As shown in FIG. 7, in some aspects, process 700 may include receiving information that indicates whether a neighbor cell supports access by UEs in a RedCap category (block 710). For example, the base station (e.g., using communication manager 150 and/or reception component 902, depicted in FIG. 9) may receive information that indicates whether a neighbor cell supports access by UEs in a RedCap category, as described above.

As further shown in FIG. 7, in some aspects, process 700 may include transmitting system information that indicates whether the neighbor cell supports access by UEs in the RedCap category (block 720). For example, the base station (e.g., using communication manager 150 and/or transmission component 904, depicted in FIG. 9) may transmit system information that indicates whether the neighbor cell supports access by UEs in the RedCap category, as described above.

Process 700 may include additional aspects, such as any single aspect or any combination of aspects described below and/or in connection with one or more other processes described elsewhere herein.

In a first aspect, the information that indicates whether the neighbor cell supports access by UEs in the RedCap category is received based at least in part on the neighbor cell changing a setting related to whether the neighbor cell supports access by UEs in the RedCap category.

In a second aspect, alone or in combination with the first aspect, the information that indicates whether the neighbor cell supports access by UEs in the RedCap category is received via an OAM interface or inter-node messaging.

In a third aspect, alone or in combination with one or more of the first and second aspects, the system information is transmitted in a SIB that contains information related to cell reselection parameters.

In a fourth aspect, alone or in combination with one or more of the first through third aspects, the SIB is SIB2, SIB3, or SIB4.

In a fifth aspect, alone or in combination with one or more of the first through fourth aspects, process 700 includes transmitting, to a UE in the RedCap category, a measurement configuration that includes one or more neighbor cells on which the UE is to perform radio resource management measurements based at least in part on the information that indicates whether the neighbor cell supports access by UEs in the RedCap category.

In a sixth aspect, alone or in combination with one or more of the first through fifth aspects, the measurement configuration excludes the neighbor cell based at least in part on an indication that the neighbor cell does not support access by UEs in the RedCap category.

In a seventh aspect, alone or in combination with one or more of the first through sixth aspects, process 700 includes excluding the neighbor cell from a set of candidate target cells for a handover for a UE in the RedCap category based at least in part on an indication that the neighbor cell does not support access by UEs in the RedCap category.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a block diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a measurement component 808 or a determination component 810, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive system information that indicates whether one or more neighbor cells support access by UEs in a RedCap category. The measurement component 808 may perform one or more RRM measurements on one or more neighbor cells that are identified as supporting access by UEs in the RedCap category based at least in part on the system information.

The reception component 802 may receive a measurement configuration, and the measurement component 808 may identify the one or more neighbor cells on which to perform the one or more RRM measurements based at least in part on the measurement configuration.

The determination component 810 may determine, based at least in part on the system information, at least one neighbor cell that does not support access by UEs in the RedCap category. The measurement component 808 may refrain from performing RRM measurements on the at least one neighbor cell that does not support access by UEs in the RedCap category.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a block diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include a handover component 908, among other examples.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the base station described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a demodulator, a MIMO detector, a receive processor, a controller/processor, a memory, or a combination thereof, of the base station described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the base station described in connection with FIG. 2. In some aspects, the transmission component 904 may be co-located with the reception component 902 in a transceiver.

The reception component 902 may receive information that indicates whether a neighbor cell supports access by UEs in a RedCap category. The transmission component 904 may transmit system information that indicates whether the neighbor cell supports access by UEs in the RedCap category.

The transmission component 904 may transmit, to a UE in the RedCap category, a measurement configuration that includes one or more neighbor cells on which the UE is to perform radio resource management measurements based at least in part on the information that indicates whether the neighbor cell supports access by UEs in the RedCap category.

The handover component 908 may exclude the neighbor cell from a set of candidate target cells for a handover for a UE in the RedCap category based at least in part on an indication that the neighbor cell does not support access by UEs in the RedCap category.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving system information that indicates whether one or more neighbor cells support access by UEs in a RedCap category; and performing one or more RRM measurements on one or more neighbor cells that are identified as supporting access by UEs in the RedCap category based at least in part on the system information.

Aspect 2: The method of Aspect 1, wherein the system information is received in a SIB that contains information related to cell reselection parameters.

Aspect 3: The method of Aspect 2, wherein the SIB is SIB2, SIB3, or SIB4.

Aspect 4: The method of any of Aspects 1-3, further comprising: receiving a measurement configuration, wherein the one or more neighbor cells on which the one or more RRM measurements are performed are identified based at least in part on the measurement configuration.

Aspect 5: The method of Aspect 4, wherein the measurement configuration excludes any neighbor cells that do not support access by UEs in the RedCap category.

Aspect 6: The method of any of Aspects 1-5, further comprising: determining, based at least in part on the system information, at least one neighbor cell that does not support access by UEs in the RedCap category; and refraining from performing RRM measurements on the at least one neighbor cell that does not support access by UEs in the RedCap category.

Aspect 7: A method of wireless communication performed by a network node, comprising: receiving information that indicates whether a neighbor cell supports access by UEs in a RedCap category; and transmitting system information that indicates whether the neighbor cell supports access by UEs in the RedCap category.

Aspect 8: The method of Aspect 7, wherein the information that indicates whether the neighbor cell supports access by UEs in the RedCap category is received based at least in part on the neighbor cell changing a setting related to whether the neighbor cell supports access by UEs in the RedCap category.

Aspect 9: The method of any of Aspects 7-8, wherein the information that indicates whether the neighbor cell supports access by UEs in the RedCap category is received via an operations, administration, and management interface or inter-node messaging.

Aspect 10: The method of any of Aspects 7-9, wherein the system information is transmitted in a SIB that contains information related to cell reselection parameters.

Aspect 11: The method of Aspect 10, wherein the SIB is SIB2, SIB3, or SIB4.

Aspect 12: The method of any of Aspects 7-11, further comprising: transmitting, to a UE in the RedCap category, a measurement configuration that includes one or more neighbor cells on which the UE is to perform radio resource management measurements based at least in part on the information that indicates whether the neighbor cell supports access by UEs in the RedCap category.

Aspect 13: The method of Aspect 12, wherein the measurement configuration excludes the neighbor cell based at least in part on an indication that the neighbor cell does not support access by UEs in the RedCap category.

Aspect 14: The method of any of Aspects 7-13, further comprising: excluding the neighbor cell from a set of candidate target cells for a handover for a UE in the RedCap category based at least in part on an indication that the neighbor cell does not support access by UEs in the RedCap category.

Aspect 15: An apparatus for wireless communication at a device, comprising a processor; memory coupled with the processor; and instructions stored in the memory and executable by the processor to cause the apparatus to perform the method of one or more of Aspects 1-6.

Aspect 16: A device for wireless communication, comprising a memory and one or more processors coupled to the memory, the one or more processors configured to perform the method of one or more of Aspects 1-6.

Aspect 17: An apparatus for wireless communication, comprising at least one means for performing the method of one or more of Aspects 1-6.

Aspect 18: A non-transitory computer-readable medium storing code for wireless communication, the code comprising instructions executable by a processor to perform the method of one or more of Aspects 1-6.

Aspect 19: A non-transitory computer-readable medium storing a set of instructions for wireless communication, the set of instructions comprising one or more instructions that, when executed by one or more processors of a device, cause the device to perform the method of one or more of Aspects 1-6.

Aspect 20: An apparatus for wireless communication at a device, comprising a processor; memory coupled with the processor; and instructions stored in the memory and executable by the processor to cause the apparatus to perform the method of one or more of Aspects 7-14.

Aspect 21: A device for wireless communication, comprising a memory and one or more processors coupled to the memory, the one or more processors configured to perform the method of one or more of Aspects 7-14.

Aspect 22: An apparatus for wireless communication, comprising at least one means for performing the method of one or more of Aspects 7-14.

Aspect 23: A non-transitory computer-readable medium storing code for wireless communication, the code comprising instructions executable by a processor to perform the method of one or more of Aspects 7-14.

Aspect 24: A non-transitory computer-readable medium storing a set of instructions for wireless communication, the set of instructions comprising one or more instructions that, when executed by one or more processors of a device, cause the device to perform the method of one or more of Aspects 7-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving system information that indicates whether one or more neighbor cells support access by UEs in a reduced capability (RedCap) category; and
performing one or more radio resource management (RRM) measurements on one or more neighbor cells that are identified as supporting access by UEs in the RedCap category based at least in part on the system information.

2. The method of claim 1, wherein the system information is received in a system information block (SIB) that contains information related to cell reselection parameters.

3. The method of claim 2, wherein the SIB is SIB2, SIB3, or SIB4.

4. The method of claim 1, further comprising:
receiving a measurement configuration, wherein the one or more neighbor cells on which the one or more RRM measurements are performed are identified based at least in part on the measurement configuration.

5. The method of claim 4, wherein the measurement configuration excludes any neighbor cells that do not support access by UEs in the RedCap category.

6. The method of claim 1, further comprising:
determining, based at least in part on the system information, at least one neighbor cell that does not support access by UEs in the RedCap category; and
refraining from performing RRM measurements on the at least one neighbor cell that does not support access by UEs in the RedCap category.

7. A method of wireless communication performed by a network node, comprising:
receiving information that indicates whether a neighbor cell supports access by user equipments (UEs) in a reduced capability (RedCap) category; and
transmitting system information that indicates whether the neighbor cell supports access by UEs in the RedCap category.

8. The method of claim 7, wherein the information that indicates whether the neighbor cell supports access by UEs in the RedCap category is received based at least in part on the neighbor cell changing a setting related to whether the neighbor cell supports access by UEs in the RedCap category.

9. The method of claim 7, wherein the information that indicates whether the neighbor cell supports access by UEs in the RedCap category is received via an operations, administration, and management interface or inter-node messaging.

10. The method of claim 7, wherein the system information is transmitted in a system information block (SIB) that contains information related to cell reselection parameters.

11. The method of claim 10, wherein the SIB is SIB2, SIB3, or SIB4.

12. The method of claim 7, further comprising:
transmitting, to a UE in the RedCap category, a measurement configuration that includes one or more neighbor cells on which the UE is to perform radio resource management measurements based at least in part on the information that indicates whether the neighbor cell supports access by UEs in the RedCap category.

13. The method of claim 12, wherein the measurement configuration excludes the neighbor cell based at least in part on an indication that the neighbor cell does not support access by UEs in the RedCap category.

14. The method of claim 7, further comprising:
excluding the neighbor cell from a set of candidate target cells for a handover for a UE in the RedCap category based at least in part on an indication that the neighbor cell does not support access by UEs in the RedCap category.

15. A user equipment (UE) for wireless communication, comprising:
a memory; and
one or more processors, coupled to the memory, configured to:
receive system information that indicates whether one or more neighbor cells support access by UEs in a reduced capability (RedCap) category; and
perform one or more radio resource management (RRM) measurements on one or more neighbor cells that are identified as supporting access by UEs in the RedCap category based at least in part on the system information.

16. The UE of claim 15, wherein the system information is received in a system information block (SIB) that contains information related to cell reselection parameters.

17. The UE of claim 16, wherein the SIB is SIB2, SIB3, or SIB4.

18. The UE of claim 15, wherein the one or more processors are further configured to:
receive a measurement configuration, wherein the one or more neighbor cells on which the one or more RRM measurements are performed are identified based at least in part on the measurement configuration.

19. The UE of claim 18, wherein the measurement configuration excludes any neighbor cells that do not support access by UEs in the RedCap category.

20. The UE of claim 15, wherein the one or more processors are further configured to:
determine, based at least in part on the system information, at least one neighbor cell that does not support access by UEs in the RedCap category; and
refrain from performing RRM measurements on the at least one neighbor cell that does not support access by UEs in the RedCap category.

21. A network node for wireless communication, comprising:
a memory; and
one or more processors, coupled to the memory, configured to:
receive information that indicates whether a neighbor cell supports access by user equipments (UEs) in a reduced capability (RedCap) category; and
transmit system information that indicates whether the neighbor cell supports access by UEs in the RedCap category.

22. The network node of claim 21, wherein the information that indicates whether the neighbor cell supports access by UEs in the RedCap category is received based at least in part on the neighbor cell changing a setting related to whether the neighbor cell supports access by UEs in the RedCap category.

23. The network node of claim 21, wherein the information that indicates whether the neighbor cell supports access by UEs in the RedCap category is received via an operations, administration, and management interface or inter-node messaging.

24. The network node of claim 21, wherein the system information is transmitted in a system information block (SIB) that contains information related to cell reselection parameters.

25. The network node of claim 24, wherein the SIB is SIB2, SIB3, or SIB4.

26. The network node of claim 21, wherein the one or more processors are further configured to:
transmit, to a UE in the RedCap category, a measurement configuration that includes one or more neighbor cells on which the UE is to perform radio resource management measurements based at least in part on the information that indicates whether the neighbor cell supports access by UEs in the RedCap category.

27. The network node of claim 26, wherein the measurement configuration excludes the neighbor cell based at least in part on an indication that the neighbor cell does not support access by UEs in the RedCap category.

28. The network node of claim 21, wherein the one or more processors are further configured to:
exclude the neighbor cell from a set of candidate target cells for a handover for a UE in the RedCap category based at least in part on an indication that the neighbor cell does not support access by UEs in the RedCap category.
